(19) United States
(12) Patent Application Publication
(10) Pub. No.: US 2006/0131223 A1
(43) Pub. Date: Jun. 22, 2006

(54) Apparatus for producing active water

(76) Inventors: Zhiwei Hou, Jiangsu (CN); Guocai Xujiang, Jiangsu (CN); Zhengke Jiang, Jiangsu (CN)

Correspondence Address: DORSEY & WHITNEY LLP;INTELLECTUAL PROPERTY DEPARTMENT, 50 SOUTH SIXTH STREET, MINNEAPOLIS, MN, 55402-1498, US

(21) Appl. No.: 10/540,356

(22) PCT Filed: Dec. 15, 2003
(86) PCT No.: PCT/CN03/01062

§ 371 Date: Jan. 31, 2006

(30) Foreign Application Priority Data
Dec. 27, 2002 (CN) 0229038.8

(51) Int. Cl. C02F 1/48

(52) U.S. Cl. 210/222; 99/275

(57) ABSTRACT

This practical new type of device deals with the domain of water treatment technology. It is a device that prepares water of small molecular groups in various polymerization forms under varied operation conditions. It is applicable to various fields including planting, human health care, bio-engineering, descaling of thermal systems and printing and dyeing in textile industry. The new type has these features: The magnetizer is installed in the inner core, and the permanent magnet is installed in the magnetizer; Its advantages are: The structure is fresh, the adaptability is wide, the function is multiple, and the effect is stable and evident (for example, in vegetable growing, the yield of the various vegetables irrigated by the active water increased by 30%-103%).

### FIELD OF THE INVENTION

This practical new type of device deals with the domain of water treatment technology. It is a device that prepares water of small molecular groups in various polymerization forms under varied operation conditions. It is applicable to various fields including planting, human health care, bio-engineering, descaling of thermal systems and printing and dyeing in textile industry.

### BACKGROUND OF THE INVENTION

Water is the most common substance in nature. In broad sense, it is the source of everything on earth. Living beings or inanimate objects, everything in nature relates to water directly or indirectly: Water is the essential prerequisite for life forms to exist and procreate; water is the media and condition for inanimate objects to change. In the forming of the earth, in the process of human evolution, and in the development of modern civilization, water system (including aqueous solution) plays a very special role that any other substance could never do. As the modern civilized society develops, water is used in every field of the national economy to fulfill various purposes in production and is used at every moment in people's daily life to meet various demands of human survival. So, to explore and study the efficient use of water and to let all substances gain the active water that they need has become an important topic that is universally cared about. For this purpose people made constant efforts in the last two decades and produced various water treatment devices, especially in the field of drinking water. There are water purifiers, magnetized drink water cups, devices for water activation and magic kettles. Purified water produced by the method of reverse osmosis is made and drank most universally. However this one-sided attention paid on purification of water and neglect of its active effect on human physiological function failed to bring about the desired effect and sometimes even produced negative effect. In agriculture and industry, though people noticed that different water quality may lead to different results and therefore produced many devices for magnetizing water, the effect of these devices are not stable, i.e. sometimes being effective but sometimes not, therefore these devices cannot be widely used in the producing field.

### SUMMERY OF THE INVENTION

This practical new type of device provides a kind of multi-functional active water preparing device that stably prepares water of small molecular groups in various polymerization forms under varied operation conditions (at different speeds of water flow of water flow and in different combination of magnetic fields) and under varied intensity of field. It provides the stable active effect of water that different carriers (i.e. the substance that the water is applied to) need.

The technical design of this practical new type of device is: It consists of outer casing, inner core, and upper and lower covers. The inner core is set in the outer casing, the outer casing is sealed with source nipple, and on each end of the casing there are upper cover and lower cover. The inner core is the magnetic channel of a static gradient magnetic field. The static gradient magnetic field is in the web-shaped poly-magnet magnetic circuits which are formed by permanent magnets, and its intensity varies according to the different parameters of the permanent magnets. Verticalize this practical new type of device and connect it in series with the water supply system so that water can flow through the device vertically at varied speeds and at different flow rates, providing the different active effects of water that different carriers (i.e. the object that the water is applied to) need.

The working principle of the technical design of this practical new type of device is: Water is a simple compound composed of 2 hydrogen atoms and 1 oxygen atom that are connected together by 2 atomic bonds. Water in nature does not exist in the form of singular molecules, but in molecule groups. The structure of the group is not permanent, but is variable. Collection and separation under certain conditions are characteristic of water molecules in their existence and movement. It's the structural features of water molecules that determine the characteristic of water variation. First, a water molecule is composed of two hydrogen atoms and one oxygen-atom that are connected together by 2 atomic bonds, the angle between the 2 bonds being 105°. Due to its unsymmetrical structure, a water molecule is polarized. So water can become hydrogen and oxygen through electrolysis. Furthermore, the chemical bonds can be bent more or less with help of energy from laser, far-infrared lights or magnetic fields, and the angle between the bonds is varied, so as to intensify the polarity of water molecules. Second, the hydrogen atoms of a water molecule and the oxygen atom of an adjacent water molecule have attraction force between them, which is called “hydrogen bond”. Different from the chemical bonds, it is association between water molecules, and can be called “molecule bond”. In a compound molecule, every bond, which is linked to an atom of strong negative polarity, is called a “hydrogen bond”. A hydrogen bond differs from an atomic bond in that the former is longer and its energy is smaller, and is easy to break. Under the hydrogen bond action, water molecules associate with water molecules nearby to form a larger group of molecules, the so-called associated water molecular group.

Usually, tap water, well water, and rainwater are all associated water of big molecular groups. If some energy is conveyed to water molecular groups, the atomic bond will be varied, and the molecule bond will also be broken, causing big molecular groups to break down into small groups. Compared with large molecular group water, small molecular group water has stronger penetration, higher solubility and oxygen absorption, stronger surface tensile force, electric conductivity and polarity. Small molecular group water of different structures may have different adaptability and active effects of water when applied to different substances (i.e. different objects or carriers). This practical new type of device can operate under varied operation conditions (at different speeds of water flow and in different combination of magnetic fields) and under varied intensity of field, and has many functions. It can stably prepare active water which remains harmonious with the physiological function of the human body, promotes the metabolism of cells in the human body, strengthens the human immunities and improves health; it can stably prepare active water for descaling and preventing hard scale from forming in boilers, kettles, and other thermal systems; it can stably prepare for food crops, vegetables, fruits and flowers the active water, and among its various bio-effects and ecological efficiency are promoting the cell metabolism of vegetation, increasing production and vitality, and improving the quality of both the plant and the soil; finally it can stably prepare active water that has different active effects for various fields such as pharmacy, sewage treatment, and the printing, bleaching, and dyeing in textile industry. That is why the device is named a kind of multifunctional active water preparing device. It consists of outer casing, inner core, and upper and lower covers. The inner core is set in the outer casing, the outer casing is sealed with source nipple, and on each end of the casing there are upper cover and lower cover. The inner core is the magnetic channel of a static gradient magnetic field: the static gradient magnetic field is in the web-shaped poly-magnet magnetic circuits which are formed by permanent magnets, and its intensity varies according to the different parameters of the permanent magnets. Verticalize this practical new type of device and connect it in series with the water supply system so that water can flow through the device vertically at varied speeds and at different flow rates, providing the different active effects of water that different carriers (i.e. the substance that the water is applied to) need.

### Brief Description of the drawings

Further instruction of this practical new type is shown in the following drawings and examples:

FIG. 1—Cutaway view of the practical new type;

FIG. 2—Profile section of the outer casing;

FIG. 3—Cross section of the outer casing in FIG. 2;

FIG. 4—Profile section of the inner core;

FIG. 5—Cross section of the inner core in FIG. 4;

FIG. 6—Profile section of the upper and lower covers

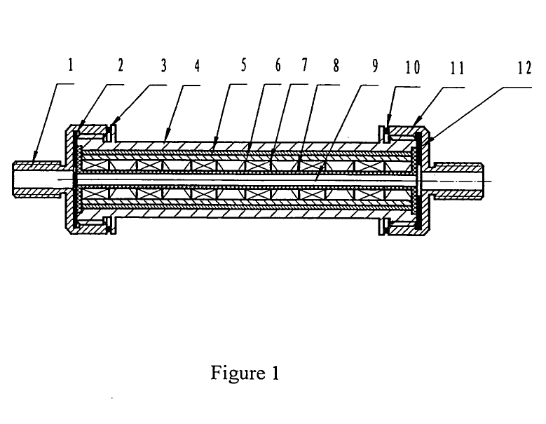

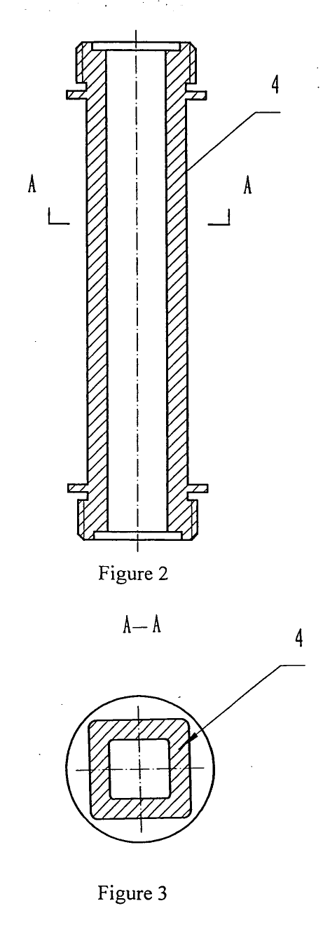

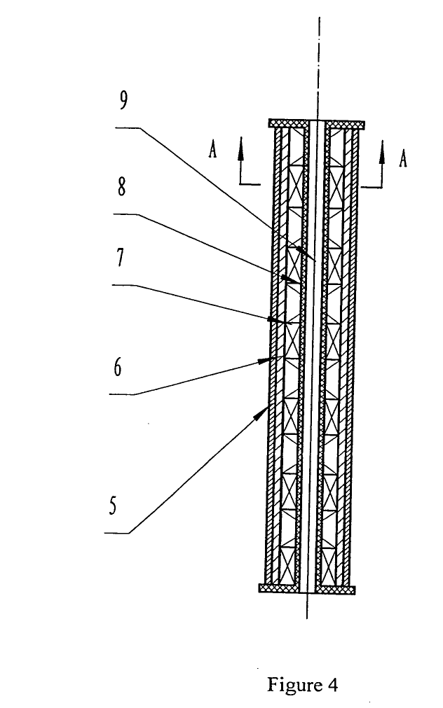

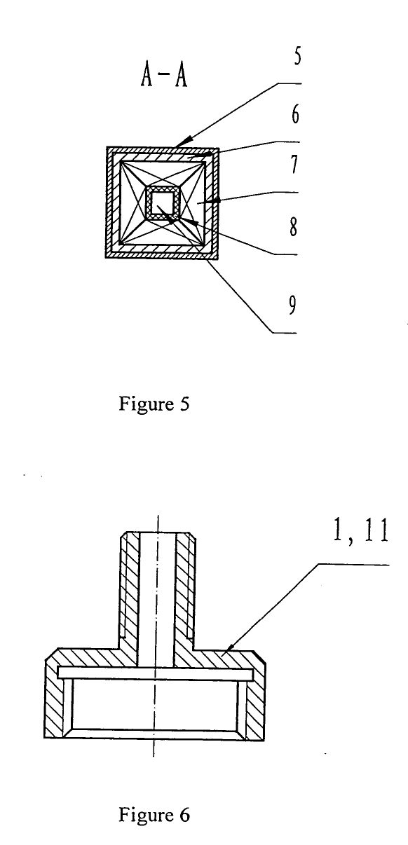

As shown in FIG. 1˜6, this practical new type of device consists of upper cover 1, gasket seal 2, O-shape lock ring 3, outer casing 4, inner core 5, magnetizer 6, permanent magnet 7, rust preventing PP-R plastic pipe bushing 8, magnetic field channel 9, O-shape lock ring 10, lower cover 11, gasket seal 12.

### DETAILED DESCRIPTION OF THE INVENTION

As is shown is FIG. 1, the inner core 5 is set in the outer casing 4. The out casing 4, which is at its two ends connected with upper cover 1 and lower cover 11 by source nipple, is sealed with gasket seal 2 and 12 and O-shape lock ring 3 and 10. The outer casing 4 can be metallic or nonmetallic, square or round.

The new type has these features:

The magnetizer 6 is installed in the inner core 5, the permanent magnet 7 is installed in the magnetizer 6;

The out casing 4, which is at its two ends connected with upper cover 1 and lower cover 11 by source nipple, is sealed with gasket seal 2 and 12 and O-shape lock ring 3 and 10. Poles of permanent magnet 7 are spaced vertically with Pole S and Pole N one next to the opposite along the circumferential wall of magnetizer 6, forming layers of web-shaped magnetic circuits (a web of magnetic force lines), thus a multiple-layer static magnetic field channel 9 is formed. As for how many poles and what size of the magnetic field channel are needed, this will be decided by how strong the intensity of magnetic field should be. Water will posses various polymerization forms when it flows through the magnetic field channel of different magnetic field at different speeds of water flow. Driven by kinetic energy of different speeds of water flow and cut by the web of magnetic force lines in magnetic fields of different intensity, water of large molecular groups will turn into different water of small molecular groups which could provide different active effects that different carriers (i.e. the object that the water is applied to) need.

Along the inner side of the permanent magnet 7 the rust preventing PP-R plastic pipe bushing 8 is installed.

This new type has the following advantages: The structure is fresh, the adaptability is wide, the function is multiple, the effect is stable and evident, and the use is convenient. In the human health care field, hospitals chose 9 cases of patients high in cholesterol, 18 cases of patients high in triglyceride, 6 high in blood sugar for experiments with the active water prepared by this new type of device. The comparative blood tests show that, before drinking the human active water and after drinking it for 3 months, 9 cases of patients high in cholesterol restored to normal, thus the total effect rate was 100%. Of 18 cases of patients high in triglyceride, 9 restored to normal, 6 had the high indications noticeably lowered, and 3 of them failed to lower the high indications, the total effect rate was 83%. Of the 6 patients high in blood sugar, 4 had the high indications noticeably lowered and 2 failed to lower the high indications, the total effect rate was 66%. In addition, 34 patients of constipation drank the active water for 14 days, 27 returned to normal, 3 felt relief, 4 failed to feel relief, the total effect rate was 88%. In the domain of descaling of thermal systems, the results of using this practical new type of device to clean the hard scale in 0.5 ton steam boilers show that the hard scale whose thickness is 3-5 mm clinging on the inner wall of the boilers and pipes is dissolved automatically within 35 days, falling off in pieces. The descaling rate is over 95%. Further used as the making-up feed water of the boiler after descaling, the active water prepared by this device can prevent hard scale from forming. As for plant growing, a contrastive experiment was done on vegetable growing in earth with bio-active water prepared by this new type and with ordinary tap water on equal footing. Products were increased by large margins: Radish increased by 103%, cucumber by 82%, potato by 62%, string bean by 67%, tomato by 44.8%, lettuce by 46%, towel gourd by 62%. In the experimental area irrigated with the active water, when the active water was reduced by 30%, the yield was still increased noticeably. In the contrastive experiment of flower and tree cultivation, the activated water made them flourish, extended the flowering phase by nearly ⅓, lowered the wintering death rate, and what is more, it made the withered braches and stalks grow out new leaves, showing regenerative motility. When active water prepared by this new type is used in the domain of printing and dyeing in textile industry, the absorbing capacity of dyes is increased by 23%˜38%, color fastness by 1˜2 grades, and the textile is pigmentized evenly and beautifully. This new type of device can prepare water of small molecular groups under varied operation conditions for different use and active effects in various fields. Undoubtedly, spreading the application of the active water preparation device will bring about enormous social and economic effects.

We claims:

1. A kind of multifunctional active water preparing device consists of upper cover 1, gasket seal 2, O-shape lock ring 3, outer casing 4, inner core 5, magnetizer 6, permanent magnet 7, rust preventing PP-R plastic pipe bushing 8, magnetic field channel 9, O-shape lock ring 10, lower cover 11, gasket seal 12. This new type has these features: The magnetizer 6 is installed in the inner core 5, the permanent magnet 7 is installed in the magnetizer 6;

2. A kind of multifunctional active water preparing device, based on Request Item 1, which is characteristic of: The out casing 4, which is connected at it two ends with upper cover 1 and lower cover 11 by source nipple, is sealed with gasket seal 2 and 12 and O-shape lock ring 3 and 10.

3. A kind of multifunctional active water preparing device, based on Request Item 1, which is characteristic of: Poles of permanent magnet 7 are spaced with Pole S and Pole N one next to the opposite all along the circumferential wall of magnetizer 6, forming layers of web-shaped magnetic circuits (a web of magnetic force lines); thus a multiple-layer static magnetic field channel 9 is formed.

4. A kind of multifunctional active water preparing device, based on Request Item 1, which is characteristic of: Along the inner side of the permanent magnet 7 the rust preventing PP-R plastic pipe bushing 8 is installed.
